(19) United States
(12) Patent Application Publication
(10) Pub. No.: US 2006/0183088 A1
(43) Pub. Date: Aug. 17, 2006

(54) Audio-visual language teaching material and audio-visual languages teaching method

(76) Inventor: Kunio Masuko, Tokyo-To (JP)

Correspondence Address: KODA & ANDROLIA, 2029 CENTURY PARK EAST, SUITE 1140, LOS ANGELES, CA, 90067, US

(21) Appl. No.: 11/051,889

(22) Filed: Feb. 4, 2005

(30) Foreign Application Priority Data
Feb. 2, 2005 (JP) U 2005-444

(51) Int. Cl. G09B 19/06

(52) U.S. Cl. 434/157

(57) ABSTRACT

An audio-visual language teaching material for a learner to study and clarify how a word is pronounced in a sentence/paragraph is provided.

An audio-visual device 1 outputs images 5 of a speaker reading out a specific sentence/paragraph written in Language I, the voice of the speaker, and a subtitle image 6 which shows the full text of Language II translation of said specific sentence/paragraph wherein certain subtitled words are highlighted concurrently as the corresponding words are read out by the speaker.

### TECHNICAL FIELD

The present invention relates to an audio-visual language teaching material and an audio-visual language teaching method.

The present invention particularly relates to an audio-visual language teaching material in which the following are output: images of a speaker reading out a specific sentence/paragraph in a first target language to be learned (hereinafter in the present specification referred to as “Language I”); the voice of the speaker; and subtitles showing the full text of the sentence/paragraph translated into the learner's mother language (hereinafter in the present specification referred to as “Language II”) wherein certain subtitled words are highlighted concurrently as the corresponding words are read out by the speaker, whereby the speaker's mouth movements, the words pronounced in the flow of speech, and the positioning of the words within the sentence/paragraph and the meaning of the words can be learned.

The present invention also relates to an audio-visual language teaching material and an audio-visual language teaching method wherein the aids to recognize spoken words, i.e. the images of the speaker, the highlighting of the subtitled words and the subtitles themselves, are progressively reduced, thus enabling the learner to understand Language I in the situations such as in a normal conversation and telephone communication.

### BACKGROUND OF THE INVENTION

Audio-visual materials are widely used for language education.

There have been conventional audio-visual language teaching materials, or audio-visual language teaching methods using such materials, wherein the voice of a speaker in the target Language I is output with images and subtitles are displayed to show the text translated into the learner's mother language, Language II.

By providing the voice of a speaker in Language I together with the subtitled text translated into Language II in this way, the learner can understand the meaning provided by the subtitles and learn the pronunciation provided by the voice.

In the conventional audio-visual language teaching materials or teaching methods, however, words are learned and listening is practiced separately. That is, when learning words, the meaning, spelling and pronunciation of a word is taught by word, and when practicing listening, a whole sentence/paragraph is to be understood without specifically distinguishing how a word is pronounced in the sentence/paragraph. The subtitles provided for listening practice only help understanding the meaning of the whole sentence/paragraph.

A Japanese patent laid-open application publication (official gazette of Japanese Patent Application Publication No. 2001-337595) discloses the art wherein subtitles in both the target Language I and Language II, the learner's mother language, are simultaneously displayed while the voice is output in Language I. This publication also discloses the art of displaying the subtitles in Language I and Language II alternately. In either case, however, when a sentence/paragraph is read out, the full text of the sentence/paragraph is displayed as subtitles without specifically distinguishing how every word is pronounced in the sentence/paragraph.

### SUMMARY OF THE INVENTION

When studying languages, however, it is often noticed that the pronunciation of a single word is different when the word is pronounced in a sentence/paragraph.

In a sentence/paragraph, for example, a word can be pronounced continuously as one clause with a word therebefore or thereafter, and in such a case, the pronunciation of the word is quite different from the pronunciation of the word itself.

When a language learner listens to a word pronounced in a sentence/paragraph, the word, which is learned by word, can sound differently to the learner.

In addition, when a word is pronounced in a sentence/paragraph that has a certain intonation, the word can be pronounced with a somewhat different intonation from when the word is pronounced by itself.

Moreover, certain words can be pronounced extremely weakly and thus hard to hear.

The conventional audio-visual materials or audio-visual teaching method for language education have not succeeded, as described above, in clearly teaching how every word is pronounced in the flow of speech, given that the pronunciation of a word can be different depending on in which situation the word is pronounced.

Furthermore, the order of the words in a sentence is often different in language study because of the difference in grammar. For example, the order of an object and a verb in Japanese is reverse in English.

Consequently, although the voice in Language I is output while the full text of the sentence/paragraph in Language II is displayed concurrently, the pronounced words do not follow the subtitled words from the beginning.

It has been quite difficult for the learners to catch how every word is pronounced because, in order to understand pronunciation of a certain word, the learners had no other way than to recognize the output voice while expecting beforehand the order of the word which is about to be pronounced.

Consequently, the conventional subtitles are useful only as the supporting information to help understanding an outline of the meaning of the whole sentence/paragraph, provided that the purpose of the study is to understand spoken Language I.

To improve such insufficiency, the present invention provides an audio-visual language teaching material and an audio-visual language teaching method, wherein the learner can clarify how every word is pronounced in the flow of speech and can understand Language I in a normal conversation and telephone communication by a stepwise learning.

To achieve the above purposes, the audio-visual language teaching material according to the present invention is characterized in that the following are output by an audio-visual device: images of a speaker reading out a specific sentence/paragraph written in Language I; the voice of the speaker; and a subtitle image which shows the full text of Language II translation of said specific sentence/paragraph wherein certain subtitled words are highlighted concurrently as the corresponding words are read out by the speaker.

The audio-visual language teaching material according to the present invention is characterized in that the following are output by an audio-visual device in a first learning step: images of a speaker reading out a specific sentence/paragraph written in Language I; the voice of the speaker; and a subtitle image which shows the full text of Language II translation of said specific sentence/paragraph wherein certain subtitled words are highlighted concurrently as the corresponding words are read out by the speaker; and, after the output is repeated for a specific number of times, the following are output by the audio-visual device: the voice of the speaker reading out said specific sentence/paragraph; and the subtitle image which shows the full text of Language II translation of said specific sentence/paragraph wherein certain subtitled words are highlighted concurrently as the corresponding words are read out by the speaker, without outputting the images of the speaker reading out said specific sentence/paragraph written in Language I, or the images of the speaker reading out said specific sentence/paragraph written in Language I; the voice of the speaker; and the subtitle image which shows the full text of Language II translation of said specific sentence/paragraph, without the highlighting of the words in the subtitles, or the images of the speaker reading out said specific sentence/paragraph written in Language I; and the voice of the speaker, without outputting the subtitles.

The audio-visual language teaching method according to the present invention is characterized by comprising: a first learning step of outputting, by an audio-visual device for a specific number of times, images of a speaker reading out a specific sentence/paragraph written in Language I, the voice of the speaker, and a subtitle image which shows the full text of Language II translation of said specific sentence/paragraph wherein certain subtitled words are highlighted concurrently as the corresponding words are read out by the speaker, and, after the first learning step, at least one of the steps of:

(i) outputting by the audio-visual device the voice of the speaker reading out said specific sentence/paragraph, and the subtitle image which shows the full text of Language II translation of said specific sentence/paragraph wherein certain subtitled words are highlighted concurrently as the corresponding words are read out by the speaker, without outputting the images of the speaker reading out said specific sentence/paragraph written in Language I;

(ii) outputting by the audio-visual device the images of the speaker reading out said specific sentence/paragraph written in Language I, the voice of the speaker, and the subtitle image which shows the full-text of Language II translation of said specific sentence/paragraph, without the highlighting of the words in the subtitles;

(iii) outputting by the audio-visual device the images of the speaker reading out said specific sentence/paragraph written in Language I, and the voice of the speaker, without outputting the subtitles.

According to the audio-visual language teaching material of the present invention, an audio-visual device outputs images of a speaker reading out a specific sentence/paragraph written in Language I, the voice of the speaker, and a subtitle image which shows the full text of Language II translation of said specific sentence/paragraph wherein certain subtitled words are highlighted concurrently as the corresponding words are read out by the speaker.

This is effective in that the learner can more easily catch specific words with the supporting information such as the mouth movements of the speaker and the meaning provided by the subtitles, instead of relying only on the voice.

Particularly, certain subtitled words are highlighted concurrently as the corresponding words are read out, according to the present invention.

In this manner, the learner can distinguish a spoken word in a sentence/paragraph and learn the pronunciation of the word even if the word is pronounced continuously as one clause with a word therebefore or thereafter. Pronunciation of a word which is pronounced with a different intonation in a certain sentence/paragraph can also be learned.

Moreover, the present invention is also effective in learning grammar because the learner can understand the different word orders in Language I and Language II.

Furthermore, in the beginning the audio-visual device outputs images of a speaker reading out a specific sentence/paragraph written in Language I, the voice of the speaker, and a subtitle image which shows the full text of Language II translation of said specific sentence/paragraph wherein certain subtitled words are highlighted concurrently as the corresponding words are read out by the speaker, and after the study is accomplished to a certain degree, the images of the speaker, the highlighting of the words and the subtitles themselves are to be reduced progressively.

In this manner, the learner understands the spoken Language I in the beginning with the supporting information, the images of the speaker and the highlighting of the subtitled words, that helps learning the meaning. Then, progressively, the learner can understand the spoken Language I only by voice without any supporting information and can have a conversation only by voice such as telephone communication and a conversation without such supporting text information.

According to the present invention, an explanation of study points can be incorporated with images and sound before or after outputting the images of the speaker reading out a sentence/paragraph in Language I, the voice, and the subtitle image described above, thus enabling the learner to have a systematic learning.

Through such systematic learning combined with listening practice, efficient learning effect can be realized.

### BRIEF DESCRIPTION OF THE DRAWINGS

FIG. 1 is an explanatory drawing showing an audio-visual device playing an audio-visual language teaching material according to the present invention.

FIG. 2 is a flow chart exemplifying a study method using the audio-visual language teaching material according to the present invention.

FIG. 3 is a flow chart exemplifying a study method using the audio-visual language teaching material according to the present invention.

### BEST EMBODIMENTS FOR REALIZING THE INVENTION

The embodiments of the present invention are hereinafter explained with reference to the accompanying drawings.

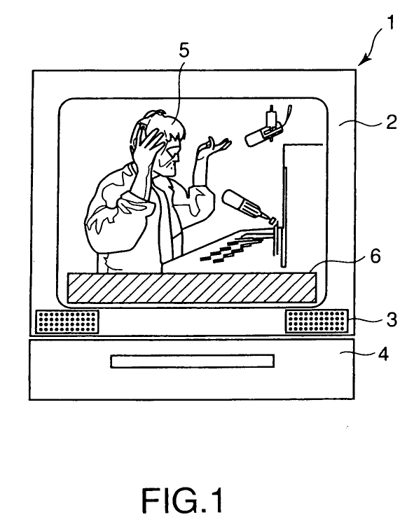

FIG. 1 exemplifies an audio-visual device outputting the images and sound of an audio-visual language teaching material according to the present invention.

An audio-visual device 1 of the present embodiment has a display apparatus 2 for outputting images, a speaker 3 for outputting sound, and a playback apparatus 4 for playing the audio-visual language teaching material.

In addition to video tapes and DVD's, the audio-visual language teaching material according to the present invention includes certain storage media (e.g. a hard disc) for storage of data downloaded from internet or the like.

When the audio-visual language teaching material is played back, images 5 of a speaker reading out a specific sentence/paragraph written in the target Language I are displayed on the screen of the display apparatus 2 as shown in FIG. 1. The speaker 3 outputs the voice of the speaker reading out the sentence/paragraph.

The screen of the display apparatus 2 provides a room for subtitles and a subtitle image 6 is displayed.

The subtitles show the full text of the sentence/paragraph read out by the speaker in Language I translated into and displayed in the learner's mother language, Language II.

In addition, the subtitles are designed to highlight certain words concurrently as the corresponding words are read out by the speaker.

The “highlighting” includes any known means that differentiate the intended words from the other words on a display. For example, the corresponding words may be displayed in a different color scale, luminance or font type from the other words.

As long as the intended words can be recognized by the highlighting, the highlighted words may be kept highlighted or may be returned to the previous text display setting after a predetermined time.

Whereas the words may be highlighted word by word, a plurality of words may be highlighted simultaneously in a case that the words are pronounced continuously as one clause.

According to the present invention, images of a speaker reading out a sentence/paragraph written in Language I and the voice of the speaker are provided and the full text of Language II translation of the sentence/paragraph is displayed as subtitles wherein certain subtitled words are highlighted concurrently as the corresponding words are read out by the speaker.

In this fashion, the mouth movements of the speaker reading out a sentence/paragraph in Language I, the meaning of the whole sentence/paragraph, and the help of the supporting information such as the instant display of the pronounced words enable the learner to catch every word.

In the event that a series of words are pronounced continuously as one clause in a sentence/paragraph, or that a word is pronounced with a different intonation in a sentence/paragraph that has a certain intonation itself, the effective language study can still be achieved because the learner can catch the words being aware of which word is pronounced.

The following explains a teaching method in which the aforementioned supporting information are progressively reduced to improve the learner's listening ability in a conversation without supporting text information such as a normal conversation and a conversation only by voice such as telephone communication.

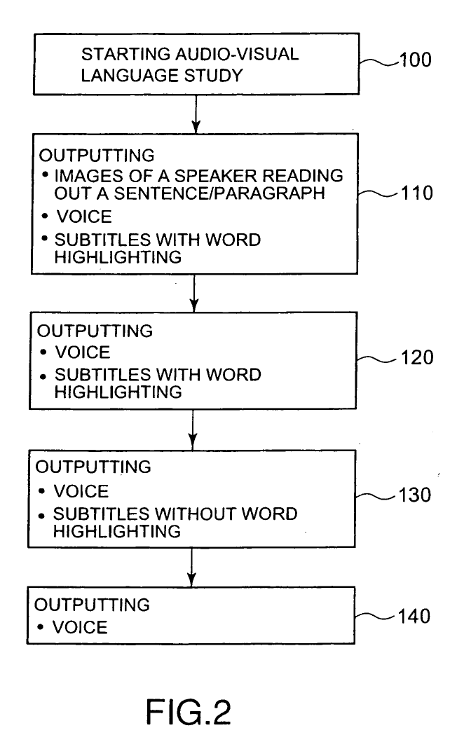

FIG. 2 shows a study method to improve the learner's listening ability in communication only by voice such as telephone communication.

Preferably, the audio-visual language teaching material according to the present invention is edited previously to achieve the following study method.

As the learning is started using the audio-visual language teaching material according to the present invention (Step 100), an audio-visual device outputs in a first learning step images of a speaker reading out a sentence/paragraph written in Language I, the voice of the speaker, and a subtitle image which shows the full text of Language II translation of the sentence/paragraph wherein certain subtitled words are highlighted concurrently as the corresponding words are read out by the speaker (Step 110).

The learner figures out at this step how each word is pronounced using the above three pieces of information and becomes able to understand the pronunciation.

In the next step, the audio-visual material device outputs the voice and the subtitle image with certain subtitled words highlighted, out of the above pieces of information, without the images of the speaker reading out the sentence/paragraph in Language I (Step 120). Since the images of the speaker are not output, it may be replaced by other images.

At this step, the mouth movements of the speaker as supporting information are not provided to the learner. However, since the learner already is able to understand the pronunciation and catch the words in the sentence/paragraph, the sentence/paragraph read out can be understood without the images of the speaker.

In the next step, the voice and the subtitles showing the full text of the sentence/paragraph in Language II are output without highlighting any words (Step 130).

At this step, the highlighted information showing which words are being pronounced is not provided to the learner. However, since the learner already is able to understand the pronunciation and catch the words in the sentence/paragraph, the sentence/paragraph read out can be understood without the highlighting of the words.

Then, finally only the voice is output (Step 140).

This step represents a situation that is identical to communication only by voice such as telephone communication. However, the learner who has gone through the above stepwise learning easily becomes able to catch the words.

In this fashion, the listening ability in communication only by voice can be improved stepwise and naturally by the audio-visual language teaching material and audio-visual language teaching method according to the present invention.

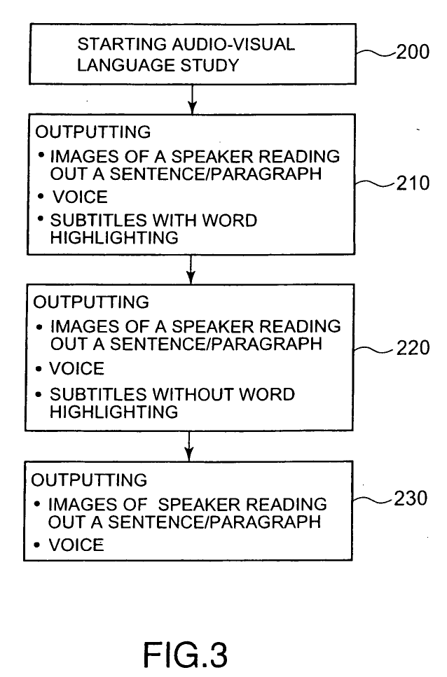

FIG. 3 shows a teaching method to improve the learner's listening ability in communication without supporting text information, such as a daily conversation.

As in the case of FIG. 2, preferably the audio-visual language teaching material according to the present invention is previously edited to achieve the following teaching method.

As the learning (education) is started using the audio-visual language teaching material according to the present invention (Step 200), an audio-visual device outputs in a first learning step images of a speaker reading out a sentence/paragraph written in Language I, the voice of the speaker, and a subtitle image which shows the full text of Language II translation of the sentence/paragraph wherein certain subtitled words are highlighted concurrently as the corresponding words are read out by the speaker (Step 210).

The learner can learn at this step how each word is pronounced by the supporting text information provided by the subtitles having the word-highlighting function.

In the next step, the audio-visual material device outputs the images of the speaker, the voice and the subtitles showing the full text of said specific sentence/paragraph in Language II without highlighting any words (Step 220).

At this step, the learner is not provided with the highlighting showing which words are being pronounced, as supporting information. However, since the learner already is able to understand the pronunciation of the words in the sentence/paragraph and is provided with the help of image information showing the subtitles of the full text of the translated sentence/paragraph and the mouth movements of the speaker, the sentence/paragraph read out can be understood.

Then, finally only the images of the speaker reading out the sentence/paragraph and the voice are output (Step 230).

This step represents a situation that is identical to communication without supporting text information, such as a daily conversation. However, the learner who has gone through the above stepwise learning easily becomes able to catch the words.

As explained above, the learner clearly understands at the beginning how a word in a sentence/paragraph is pronounced, and then the supporting information of the images of the speaker and the text display are progressively reduced so that the learner can naturally gain listening ability in communication only by voice or without supporting text information, according to the present invention.

The order and the method to progressively reduce the supporting information of the images of the speaker and the text display are not limited to FIG. 2 or FIG. 3 but the method may be a combination of FIG. 2 and FIG. 3 and, depending on the purpose of study, any supporting information may be progressively reduced in any order.

In addition, study points can be explained between the above listening practices, such as grammar description.

Such systematic learning enables the learner to effectively study languages.

Although the above embodiments have been explained on the assumption that the audio-visual language teaching material is played by an audio-visual device of the user, the present invention is not limited to the embodiments described and the audio-visual material may also be played by the user's computer to which visual data (including moving image data and text data) and audio data are transmitted serially from a center server via communication lines, or to which the data are downloaded instantly.

The “audio-visual device” of the present invention represents a device having a function as audio-visual playback equipment, including computers.

1. An audio-visual language teaching material characterized in that the following are output by an audio-visual device:
images of a speaker reading out a specific sentence/paragraph written in Language I;
the voice of the speaker; and
a subtitle image which shows the full text of Language II translation of said specific sentence/paragraph wherein certain subtitled words are highlighted concurrently as the corresponding words are read out by the speaker.

2. An audio-visual language teaching material characterized in that:
the following are output by an audio-visual device in a first learning step:
images of a speaker reading out a specific sentence/paragraph written in Language I; the voice of the speaker; and a subtitle image which shows the full text of Language II translation of said specific sentence/paragraph wherein certain subtitled words are highlighted concurrently as the corresponding words are read out by the speaker;
and, after the output is repeated for a specific number of times, the following are output by the audio-visual device:
the voice of the speaker reading out said specific sentence/paragraph; and the subtitle image which shows the full text of Language II translation of said specific sentence/paragraph wherein certain subtitled words are highlighted concurrently as the corresponding words are read out by the speaker, without outputting the images of the speaker reading out said specific sentence/paragraph written in Language I, or
the images of the speaker reading out said specific sentence/paragraph written in Language I; the voice of the speaker; and the subtitle image which shows the full text of Language II translation of said specific sentence/paragraph, without the highlighting of the words in the subtitles, or
the images of the speaker reading out said specific sentence/paragraph written in Language I; and the voice of the speaker, without outputting the subtitles.

3. An audio-visual language teaching method characterized by comprising:
a first learning step of outputting, by an audio-visual device for a specific number of times, images of a speaker reading out a specific sentence/paragraph written in Language I, the voice of the speaker, and a subtitle image which shows the full text of Language II translation of said specific sentence/paragraph wherein certain subtitled words are highlighted concurrently as the corresponding words are read out by the speaker,
and, after the first learning step, at least one of the steps of:
(i) outputting by the audio-visual device the voice of the speaker reading out said specific sentence/paragraph, and the subtitle image which shows the full text of Language II translation of said specific sentence/paragraph wherein certain subtitled words are highlighted concurrently as the corresponding words are read out by the speaker, without outputting the images of the speaker reading out said specific sentence/paragraph written in Language I;
(ii) outputting by the audio-visual device the images of the speaker reading out said specific sentence/paragraph written in Language I, the voice of the speaker, and the subtitle image which shows the full text of Language II translation of said specific sentence/paragraph, without the highlighting of the words in the subtitles;
(iii) outputting by the audio-visual device the images of the speaker reading out said specific sentence/paragraph written in Language I, and the voice of the speaker, without outputting the subtitles.
